(19) United States
(12) Patent Application Publication
(10) Pub. No.: US 2012/0254541 A1
(43) Pub. Date: Oct. 4, 2012

(54) METHODS AND APPARATUS FOR UPDATING DATA IN PASSIVE VARIABLE RESISTIVE MEMORY

(75) Inventors: Brad Beckmann, Redmond, WA (US); Lisa Hsu, Kirkland, WA (US)

(73) Assignee: Advanced Micro Devices, Inc., Sunnyvale, CA (US)

(21) Appl. No.: 13/079,518

(22) Filed: Apr. 4, 2011

(51) Int. Cl. G06F 12/08

(52) U.S. Cl. 711/122; 711/142; 711/E12.026; 711/E12.024

(57) ABSTRACT

Methods and apparatus for updating data in passive variable resistive memory (PVRM) are provided. In one example, a method for updating data stored in PVRM is disclosed. The method includes updating a memory block of a plurality of memory blocks in a cache hierarchy without invalidating the memory block. The updated memory block may be copied from the cache hierarchy to a write through buffer. Additionally, the method includes writing the updated memory block to the PVRM, thereby updating the data in the PVRM.

### FIELD OF THE DISCLOSURE

The present disclosure relates to methods and apparatus for updating data stored in memory.

### BACKGROUND OF THE DISCLOSURE

Conventional computing systems are designed to leverage the different characteristics and trade-offs between volatile and traditional non-volatile memory. For example, volatile memory (e.g., DRAM, SRAM, etc.) provides for relatively fast access byte-addressability. However, as its name implies, volatile memory loses state information following a power loss or power cycle. Conversely, traditional non-volatile memory (e.g., Flash, Hard Disk, etc.) retains state information following a power loss or power cycle. However, traditional non-volatile memory suffers from a number drawbacks. For example, traditional non-volatile memory typically requires block-based updates. That is, in order to update a single value in traditional non-volatile memory, it is often necessary to update all of the values in the memory block. As will be appreciated by those having skill in the art, this can increase latency and unnecessarily monopolize computing resources.

Accordingly, conventional computing systems save data in both volatile and traditional non-volatile types of memory. For example, data that is frequently accessed by, for example, a CPU may be temporarily stored (i.e., cached) in volatile memory that is often stored on-chip with the CPU (e.g., SRAM) for quick access. However, because volatile memory loses its state information upon a power loss or power cycle, some updates to the volatile memory-based caches (e.g., file system data) must eventually be replicated in non-volatile memory (e.g., Hard Disk, Flash, etc.) for persistent storage. Updates to the data stored in non-volatile memory are typically carried out across a relatively slow, block-based interface, such as PCI-Express (PCI-E). However, because traditional non-volatile memory is relatively slow to access in the first place, the use of a PCI-E interface does not substantially degrade the overall memory access time in conventional computing systems. That is to say, persistent storage has conventionally been implemented in non-volatile types of memory having relatively slow access times. For example, data stored in Hard Disk may take milliseconds to access, while data stored in Flash memory may take microseconds to access. As such, conventional persistent storage update mechanisms (i.e., the hardware and/or software that facilitates updates to persistent storage) employ correspondingly slow interfaces (e.g., PCI-E and other comparably slow interfaces) without significantly affecting performance.

However, new types of storage are emerging that exhibit substantially faster access times than, for example, Hard Disk and/or Flash. These new types of storage exhibit both byte-addressability (as compared to block-based addressability in memory types such as Flash) and non-volatility. Thus, in order to take advantage of the faster access times afforded by these new types of storage, it is important to utilize a correspondingly fast persistent storage update mechanism. Existing persistent storage update mechanisms are too slow to take advantage of the faster access times afforded by these new types of storage and, as such, are unsuitable for use with these new types of storage.

Meanwhile, existing main memory update mechanisms (i.e., the hardware and/or software that facilitate updates to main memory) may provide for suitable access times to these new types of storage, however, these update mechanisms fail to provide software (e.g., an operating system) with visibility of writeback completion. The inability to provide software with visibility of writeback completion can lead to inconsistency within a computing device's file system (e.g., a file system implemented by the operating system).

As known in the art, the operating system (OS) of a computing device may implement a file system designed to organize, manage, and sort data saved as files on the computing device's storage component(s) (e.g., DRAM, Hard Disk, Flash, etc.). File systems are responsible for organizing the storage component(s) physical sectors (e.g., a 512 bit physical sector of memory) into files and directories, and keeping track of which sectors belong to which files, and which sectors are not being used. Most file systems address data in fixed-sized units called “memory blocks.” In order to maintain consistency and durability, as those terms are known in the art, a file system must know when a write reaches persistent storage and must be able to define the ordering between certain writes. For example, a shadow paging file system, as known in the art, must ensure that a data file is updated before updating the Mode file to point to the new data file. However, if writeback of the Mode file occurs before the data file is written back, then the persistent storage will not be consistent. Therefore, it is important for hardware to maintain the ordering of writebacks specified by software.

Many existing main memory update mechanisms do not provide persistent storage writeback visibility to software. Other existing main memory update mechanisms may provide writeback visibility to software, but are prohibitively slow. While write policies exist that may be used to provide the necessary ordering constraints, these existing policies are insufficient for use with the new types of storage discussed above.

For example, one conventional solution to the ordering constraint issue is to use Writeback memory (WB). As the name implies, WB memory only writes to main memory when a dirty cache block (i.e., a cache block that is written while in the cache) is evicted from the cache hierarchy. The cache coherence protocol in such a system ensures that all processors (e.g., CPUs and/or GPUs) see a consistent view of WB blocks, even though main memory may actually be storing stale data.

A system employing WB memory in this manner may provide the necessary ordering constraints by retiring data to main memory using cache flush or non-temporal store instructions. For example, the CFLUSH x86 instruction invalidates all copies of the specified cache line address in the cache hierarchy and writes the block to main memory if dirty. Meanwhile, an x86 non-temporal store instruction writes data to a cache block and then invalidates the cache block main memory. Both of these instruction types are weakly ordered with respect to other memory operations and thus MFENCE or SFENCE instructions must be inserted to order them with respect to other memory operations. One drawback associated with this solution is that, when a CFLUSH instruction is used to invalidate a cache line, it causes any subsequent access to that line to miss the cache and access main memory. In a situation where certain data is being updated quite frequently, this may lead to significant performance degradation. As used herein, data may include, for example, commands/instructions or any other suitable information.

Instead of using WB memory, Uncacheable (UC) memory could be used instead. One advantage to UC memory over WB memory is that UC memory accesses are not reordered and writes directly update main memory. As such, UC provides the necessary ordering constraints without requiring MFENCE instructions. However, not allowing caching requires that all UC memory accesses go directly to main memory and all UC reads flush the write buffers, thus substantially increasing bandwidth demand and causing even greater performance degradation as compared to the WB/CFLUSH solution described above.

Another solution includes using Write-Combining (WC) memory. WC memory is similar to UC memory, but it allows writes to be coalesced and performed out-of-order with respect to each other. Further, WC reads are performed speculatively. However, WC memory is still uncacheable and thus all accesses must go to main memory leading to performance degradation.

Yet another solution involves using Write-Through (WT) memory. Similar to WB memory, WT memory can be cached. Also, writes to WT memory directly write to main memory thus eliminating the need for a CFLUSH instruction. However, the WT solution still requires substantial bandwidth because all WT memory writes must go to main memory. In sum, conventional main memory update mechanisms are unable to leverage the many advantages of new memory types exhibiting non-volatility, byte-addressability, and fast access times.

Accordingly, a need exists for methods and apparatus designed to leverage the faster access times, byte-addressability, and non-volatility of these new types of memory.

### BRIEF DESCRIPTION OF THE DRAWINGS

The disclosure will be more readily understood in view of the following description when accompanied by the below figures and wherein like reference numerals represent like elements, wherein:

FIG. 1 is a block diagram generally depicting one example of an apparatus for updating data in passive variable resistive memory (PVRM) in accordance with the present disclosure.

FIG. 2 is a block diagram generally depicting another example of an apparatus for updating data in PVRM in accordance with the present disclosure.

FIG. 3 is a block diagram generally depicting yet another example of an apparatus for updating data in PVRM in accordance with the present disclosure.

FIG. 4 is a flowchart illustrating one example of a method for updating data in PVRM.

FIG. 5 is a flowchart illustrating another example of a method for updating data in PVRM.

FIG. 6 is a flowchart illustrating yet another example of a method for updating data in PVRM.

FIG. 7 is a flowchart illustrating still another example of a method for updating data in PVRM.

### SUMMARY OF THE EMBODIMENTS

The present disclosure provides methods and apparatus for updating data in PVRM. In one example, a method for updating data in PVRM is disclosed. In this example, the method includes updating a memory block of a plurality of memory blocks in a cache hierarchy without invalidating the memory block. In one example, the memory block of the plurality of memory blocks is updated based on a non-invalidating store instruction with de-coupled writethrough (NISIDW) executed by a processor. The updated memory block may be copied from the cache hierarchy to a write through buffer. The method further includes writing the updated memory block to the PVRM, thereby updating the data in the PVRM. In one example, the PVRM may be at least one of the following types of PVRM: phase-change memory, spin-torque transfer magnetoresistive memory, and/or memristor memory.

In another example, the method may additionally include executing at least one FENCE instruction with a processor. The processor may be notified when the updated memory block has been written to the PVRM based on the FENCE instruction. In yet another example, the cache hierarchy may include at least one of a level 1 cache, a level 2 cache, and a level 3 cache. In still another example, the PVRM is byte-addressable.

The present disclosure also provides a related apparatus that may be used, for example, to carry out the above-method. In one example, the apparatus includes a cache hierarchy including a plurality of memory blocks, a write through buffer operatively connected to the cache hierarchy, PVRM operatively connected to the write through buffer, and a processor operatively connected to the cache hierarchy. In this example, the processor is operative to update a memory block of the plurality of memory blocks in the cache hierarchy without invalidating that memory block. This may be accomplished, for example, by the processor executing at least one NISIDW. Continuing with this example, the cache hierarchy is operative to copy the updated memory block to the write through buffer in response to the processor updating the memory block. The write through buffer is operative to write the updated memory block to the PVRM. In this manner, the data stored in the PVRM may be updated.

In one example of the apparatus, the PVRM is operatively connected to the write through buffer over an on-die interface, such as a double data rate interface, such that the write through buffer is operative to write the updated memory block to the PVRM over the on-die interface. In another example, the processor is further operative to execute at least one FENCE instruction. Each FENCE instruction is operative to cause the write through buffer to notify the processor when it has written the updated memory block to the PVRM. In yet another example, the apparatus also includes at least one additional processor. In this example, the processor and the at least one additional processor have a consistent global view of data in the PVRM following the execution of each at least one FENCE instruction by the processor.

The present disclosure also provides another method for updating data in PVRM. In one example, this method includes transmitting, by a processor, control information to a PVRM controller identifying which at least one memory block of a plurality of memory blocks in a cache hierarchy to copy from the cache hierarchy to the PVRM. The at least one identified memory block may also be copied from the cache hierarchy to the PVRM in response to the control information. In this manner, the data stored in the PVRM may be updated.

In one example, copying the at least one identified memory block from the cache hierarchy to the PVRM includes copying the identified memory block over an on-die interface, such as a double data rate interface. In one example, the PVRM may be at least one of the following types of PVRM: phase-change memory, spin-torque transfer magnetoresistive memory, and/or memristor memory.

In one example, the method also includes obtaining, by the processor, completion notification information. The completion notification information is operative to notify the processor that the at least one identified memory block has been copied from the cache hierarchy to the PVRM. The completion notification information may be obtained in several ways. In one example, the completion notification information is obtained by the processor polling a status bit associated with the PVRM controller. In this example, the status bit indicates whether or not the at least one identified memory block has been copied from the cache hierarchy to the PVRM. In another example, the completion notification information is obtained by the processor receiving a processor interrupt signal from the PVRM controller indicating that the at least one identified memory block has been copied from the cache hierarchy to the PVRM. In still another example, the cache hierarchy may include at least one of a level 1 cache, a level 2 cache, and a level 3 cache.

The present disclosure also provides a related apparatus that may be used, for example, to carry out the aforementioned method. In one example, the apparatus includes a cache hierarchy including a plurality of memory blocks, PVRM, a PVRM controller operatively connected to the cache hierarchy and PVRM, and a processor operatively connected to the PVRM controller. In this example, the processor is operative to transmit control information to the PVRM controller identifying which at least one memory block of the plurality of memory blocks to copy from the cache hierarchy to the PVRM. Continuing with this example, the PVRM controller is operative to copy the at least one identified memory block from the cache hierarchy to the PVRM in response to the control information.

In one example the processor is operative to obtain completion notification information operative to notify the processor that the at least one identified memory block has been copied from the cache hierarchy to the PVRM. The completion notification information may be obtained, for example, using any of the above-described techniques (e.g., polling a status bit and/or via a processor interrupt signal). In yet another example, the PVRM is operatively connected to the cache hierarchy over an on-die interface, such as a double data rate interface, such that the PVRM controller is operative to copy the at least one identified memory block from the cache hierarchy to the PVRM over the on-die interface.

Among other advantages, the disclosed methods and apparatus provide new persistent storage update mechanisms having access speeds compatible with PVRM and a new non-invalidating store instruction with de-coupled writethrough (NISIDW). Executing a NISIDW in a computing system containing the new persistent storage update mechanism provides software with visibility of writeback completion in order to maintain a consistent view of the state of persistent storage (e.g., PVRM). Furthermore, the NISIDW is capable of updating a cache hierarchy and PVRM, without invalidating the updated memory block. Other advantages will be recognized by those of ordinary skill in the art.

### DETAILED DESCRIPTION OF THE EMBODIMENTS

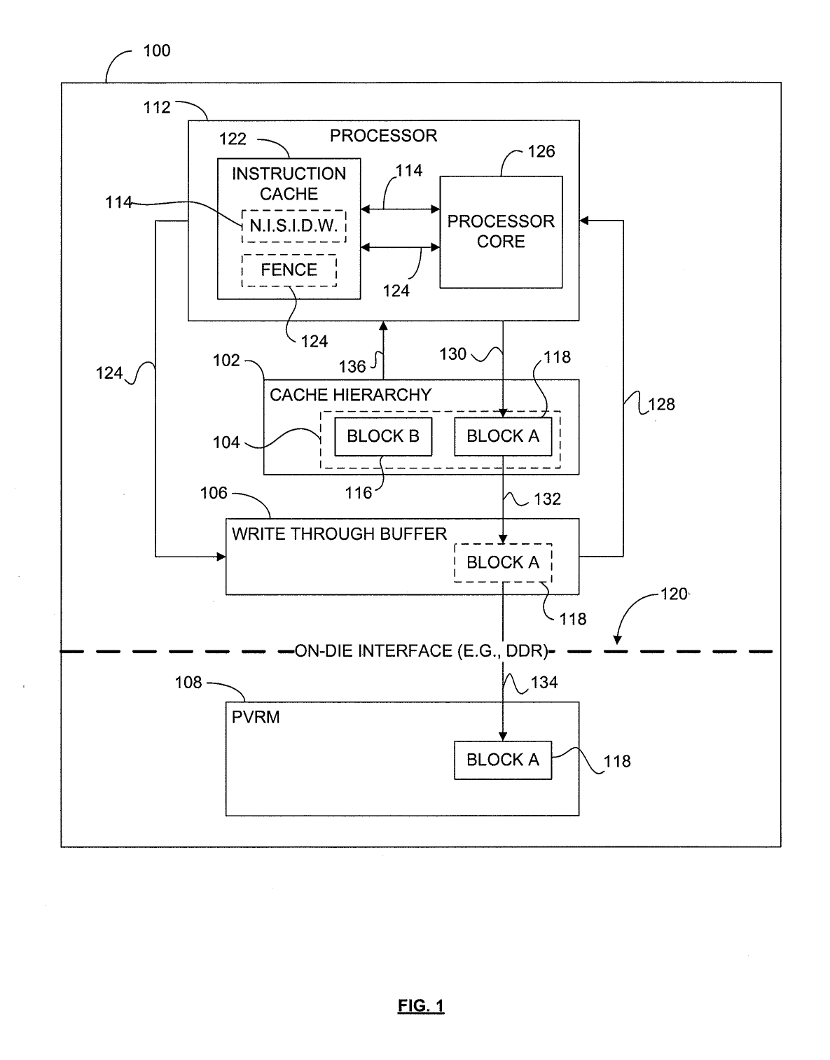

The following description of the embodiments is merely exemplary in nature and is in no way intended to limit the disclosure, its application, or uses. FIG. 1 illustrates one example of an apparatus 100 (i.e., a new persistent storage update mechanism) for updating data in passive variable resistive memory (PVRM) 108 in accordance with the present disclosure. In one example, the PVRM may comprise any one of phase-change memory, spin-torque transfer magnetoresistive memory, memristor memory, or any other suitable form of non-volatile passive variable resistive memory. The apparatus 100 may exist, for example, in a personal computer (e.g., a desktop or laptop computer), personal digital assistant (PDAs), cellular telephone, tablet (e.g., an Apple® iPad®), one or more networked computing devices (e.g., server computers or the like, wherein each individual computing device implements one or more functions of the apparatus 100), camera, or any other suitable electronic device. The apparatus 100 includes a processor 112. The processor 112 may comprise one or more microprocessors, microcontrollers, digital signal processors, or combinations thereof operating under the control of executable instructions stored in the storage components. In one example, the processor 112 is a central processing unit (CPU).

PVRM is a broad term used to describe any memory technology that stores state in the form of resistance instead of charge. That is, PVRM technologies use the resistance of a cell to store the state of a bit, in contrast to charge-based memory technologies that use electric charge to store the state of a bit. PVRM is referred to as being passive due to the fact that it does not require any active semiconductor devices, such as transistors, to act as switches. These types of memory are said to be “non-volatile” due to the fact that they retain state information following a power loss or power cycle. Passive variable resistive memory is also known as resistive non-volatile random access memory (RNVRAM or RRAM).

Examples of PVRM include, but are not limited to, Ferroelectric RAM (FeRAM), Magnetoresistive RAM (MRAM), Memristors, Phase Change Memory (PCM), and Spin-Torque Transfer MRAM (STT-MRAM). While any of these technologies may be suitable for use in conjunction with an apparatus, such as the apparatus 100 disclosed herein, PCM, memristors, and STT-MRAM are contemplated as providing an especially nice fit and are therefore discussed below in additional detail.

Phase change memory (PCM) is a PVRM technology that relies on the properties of a phase change material, generally chalcogenides, to store state. Writes are performed by injecting current into the storage device, thermally heating the phase change material. An abrupt shutoff of current causes the material to freeze in an amorphous state, which has high resistivity, whereas a slow, gradual reduction in current results in the formation of crystals in the material. The crystalline state has lower resistance than the amorphous state; thus a value of 1 or 0 corresponds to the resistivity of a cell. Varied current reduction slopes can produce in-between states, allowing for potential multi-level cells. A PCM storage element consists of a heating resistor and chalcogenide between electrodes, while a PCM cell is comprised of the storage element and an access transistor.

Memristors are commonly referred to as the “fourth circuit element,” the other three being the resistor, the capacitor, and the inductor. A memristor is essentially a two-terminal variable resistor, with resistance dependent upon the amount of charge that passed between the terminals. Thus, a memristor's resistance varies with the amount of current going through it, and that resistance is remembered even when the current flow is stopped. One example of a memristor is disclosed in corresponding U.S. Patent Application Publication No. 2008/0090337, having a title “ELECTRICALLY ACTUATED SWITCH”, which is incorporated herein by reference.

Spin-Torque Transfer Magnetoresistive RAM (STT-MRAM) is a second-generation version of MRAM, the original of which was deemed “prototypical” by the International Technology Roadmap for Semiconductors (ITRS). MRAM stores information in the form of a magnetic tunnel junction (MTJ), which separates two ferromagnetic materials with a layer of thin insulating material. The storage value changes when one layer switches to align with or oppose the direction of its counterpart layer, which then affects the junction's resistance. Original MRAM required an adequate magnetic field in order to induce this change. This was both difficult and inefficient, resulting in impractically high write energy. STT-MRAM uses spin-polarized current to reverse polarity without needing an external magnetic field. Thus, the STT technique reduces write energy as well as eliminating the difficult aspect of producing reliable and adequately strengthen magnetic fields. However, STT-MRAM, like PCM, requires an access transistor and thus its cell size scaling depends on transistor scaling.

In any event, the processor 112 includes an instruction cache 122 operatively connected to a processor core 126 over a suitable communication channel, such as an on-die bus. The instruction cache 122 is operative to store instructions that may be executed by the processor core 126 of the processor 112, such as one or more non-invalidating store instructions 114 and/or FENCE instructions 124. As used with respect to the embodiments described herein, a FENCE instruction may include, for example, any x86 FENCE instruction (e.g., MFENCE, SFENCE, LFENCE, etc.). In one example, the FENCE instruction may include a new FENCE instruction (i.e., a proprietary FENCE instruction not included in the x86 ISA) that does not complete until a write through buffer, such as the write through buffer 106, is empty. The apparatus 100 also includes a cache hierarchy 102.

The cache hierarchy 102 may include any suitable number of cache levels. For example, in one embodiment, the cache hierarchy 102 may include only a level 1 cache. However, it is recognized that the cache hierarchy 102 may include several different cache levels as well (e.g., a level 1 cache, level 2 cache, and level 3 cache). The cache hierarchy 102 is operatively connected to the processor 112 over one or more suitable communication channels, such as one or more on-die or off-die buses, as known in the art. The cache hierarchy 102 may comprise, for example, any combination of volatile/non-volatile memory components such as read-only memory (ROM), random access memory (RAM), electrically erasable programmable read-only memory (EE-PROM), PVRM, etc. For example, in one embodiment, the cache hierarchy 102 may comprise SRAM (static random access memory) and/or DRAM (dynamic random access memory). The cache hierarchy 102 includes a plurality of memory blocks 104, such as memory block 116 (labeled “BLOCK B”) and updated memory block 118 (labeled “BLOCK A”). As used with respect to the embodiments described herein, a memory block refers to the smallest adjacent group of bytes that the persistent storage update mechanism (i.e., the components of the apparatus 100) transfers. For modern computing systems, memory blocks are typically 64 to 128 bytes.

The apparatus 100 also includes a write through buffer 106. The write through buffer 106 is operatively connected to the cache hierarchy 102 and processor 112 over one or more suitable communication channels (e.g., buses, on-die interfaces, off-die interfaces, etc.) as known in the art. The write through buffer 116 may comprise, for example, any combination of volatile/non-volatile memory components such as read-only memory (ROM), random access memory (RAM), electrically erasable programmable read-only memory (EE-PROM), PVRM, etc. Finally, the apparatus 100 includes PVRM 108 operatively connected to the write through buffer 106 via an on-die interface 120, such as a double data rate (DDR) interface.

The PVRM 108 includes data, such as data representing files, commands/instructions, or any other suitable information. The PVRM 108 is operative to store one or more memory blocks, such as updated memory block 118.

In one example, the apparatus 100 operates as follows. Stored software (e.g., a stored computer program) running on the processor 112 causes the processor to issue a non-invalidating store instruction with de-coupled writethough 114 (NISIDW). The NISIDW 114 is communicated from the instruction cache 122 of the processor 112 to the processor's core 126 where the NISIDW 114 is translated into a write request 130 with de-coupled writethrough 132. The write request 130 may identify, for example, the address in memory containing the data to be updated and the new values that the data at that address in memory should take. The write request 130 with de-coupled writethrough 132 is then issued to the cache hierarchy 102. Again, the cache hierarchy 102 may comprise, for example, a level 1 cache (e.g., SRAM, DRAM, PVRM, etc. on the processor die).

If the write request 130 hits the cache hierarchy 102 (i.e., if the particular memory block sought to be updated resides within the cache hierarchy 102), then the appropriate memory block is updated with the desired values. For example, and with continued reference to FIG. 1, the write request 130 may update “BLOCK A,” such that updated BLOCK A constitutes an updated memory block 118. While BLOCK A is used to illustrate an updated memory block 118, it is recognized that any number of different memory blocks may be updated as desired. However, as the NISIDW name implies, the write request 130 to the cache hierarchy 102 does not invalidate the memory block that is updated. Rather, a copy of the updated memory block 118 is maintained in the cache hierarchy 102 following the update. In this manner, the write request 130 completes from the perspective of the processor 112 as soon as the appropriate memory block is updated. Thus, any subsequent writethroughs 132 to the PVRM 108 may be coalesced and issued out-of-order with respect to other writes allowing them to be buffered in a separate write through buffer 106, as will be discussed in additional detail below. As such, these writethroughs 132 will not create the same bandwidth burden as existing WT memory writethroughs, which cannot be issued out-of-order.

Continuing, the cache hierarchy 102 may then return an acknowledgement signal 136 to the processor 112 indicating that the write operation completed successfully. Upon receiving the acknowledgement signal 136, the processor core 126 may proceed to execute the next instruction in the instruction sequence. At or about the same time that the cache hierarchy 102 returns the signal 136 to the processor 112, the cache hierarchy 102 may also issue the de-coupled writethrough 132 to the write through buffer 106. The de-coupled writethrough 132 contains substantially the same data as the write request 130. That is, the de-coupled writethrough 132 may identify, for example, the address in memory containing the data to be updated and the new values that the data in that address in memory should take. With reference to FIG. 1, this concept is illustrated by showing the updated memory block 118 being copied from the cache hierarchy 102 (and by the cache hierarchy 102) to the write through buffer 106.

The write through buffer 106 may then write the updated memory block 118 (i.e., transfer data representing the updated memory block 118) to the PVRM 108 when the on-die interface 120 is able to consume the PVRM write request 134. That is to say, in one example, the write through buffer 106 may contain data representing a plurality of memory blocks designated for storage in the PVRM 108. In such a circumstance, the write through buffer 106 may not be able to consume a given PVRM write request 134 corresponding to a particular memory block (e.g., updated memory block 118) immediately because it needs to write other memory blocks residing in the buffer 106. It is recognized that the write through buffer 106 may implement any suitable invalidation scheme known in the art, such as, for example, a first-in-first-out (FIFO) invalidation scheme or an out-of-order invalidation scheme, as desired. In this manner, the data stored in the PVRM 108 may be characterized as having been updated following the write through buffer's 106 writing of a given memory block (e.g., updated memory block 118).

Notably, the write through buffer 106 is operatively connected to the PVRM 108 over the on-die interface 120. An on-die interface 120, as opposed to an off-die interface, is utilized in the present disclosure in order to optimize the relatively fast access time of PVRM 108 as compared to traditional non-volatile RAM. The on-die interface may comprise, for example, a DDR interface, a DDR2 interface, a DDR3 interface, or any other suitable on-die interface known in the art. The high access speeds of the PVRM 108 would be mitigated if a slower (e.g., an off-die) interface were to be used.

The aforementioned process of updating the PVRM 108 may continue for as many updates as desired until a FENCE instruction 124 is issued. As known in the art, a FENCE instruction 124 is a class of instruction that causes a processor (e.g., processor 112) to enforce an ordering constraint on memory operations (e.g., reads/writes) issued before and after the FENCE instruction 124. That is to say, a FENCE instruction 124 performs a serializing operation on all stores to memory (e.g., write requests 130/de-coupled writethroughs 132) that were issued prior to the FENCE instruction 124. This serializing operation ensures that every store instruction that precedes the FENCE instruction 124 in program order is globally visible before any load/store instruction that follows the FENCE instruction 124 is globally visible. In this manner, software (e.g., an OS implementing a file system) knows what operations have fully completed in order to determine the state of storage. Therefore, if a crash occurs, the software knows whether a given operation succeed or needs to be replayed. That is, the FENCE instruction 124 of the present disclosure ensures visibility of updates to PVRM 108 to maintain a consistent view of the state of storage. In this manner, the apparatus 100 may prevent unpredictable behavior in concurrent programs and device drivers that is known to occur when memory operations are reordered across multiple threads of instructions.

In the apparatus 100, a FENCE instruction 124 is issued to signal the end of one logical group of instructions (e.g., write requests 130) so as to provide software with visibility of PVRM updates in order to maintain a consistent view of the state of storage. When desired (e.g., at the end of a logical group of instructions), the FENCE instruction 124 is issued by the processor 112 to the write through buffer 106 requesting that the write through buffer 106 notify the processor 112 when it is empty (i.e., when it has written all of its memory blocks to the PVRM 108). When the write through buffer 106 is empty, it transmits notification information 128 to the processor 112. The notification information 128 is operative to inform the processor 112 that the write through buffer 106 is empty. This process is advantageous because, following the receipt of the notification information 128, the software running on the processor 112 may cause the processor to update, for example, a file system state to alert other apparatus components (e.g., one or more other processors in addition to processor 112) that the most up-to-date versions of particular memory blocks (e.g., updated memory block 118) are located in the PVRM 108. In this manner, the processor 112 and each additional processor (not shown) have a universal view of the data stored in the PVRM 108 following the execution of each at least one FENCE instruction 124 by the processor 112.

While the above discussion has centered around the situation where a write request 130 hits the cache hierarchy 102, it is recognized that in some circumstances the write request 130 will miss the cache hierarchy 102. In such as situation, the cache hierarchy 102 (e.g., a level 1 cache within the hierarchy) may issue a read-exclusive request corresponding to the memory block that the write request 130 sought to update. The read-exclusive request is responded to by the portion of memory containing the block at issue (e.g., another cache and/or the PVRM 108 itself) and grants the cache hierarchy 102 (e.g., the level 1 cache) exclusive permission and data for the block. Once exclusive permission has been granted, the process proceeds as though the write request 130 had hit the cache hierarchy 102 initially.

In this manner, the apparatus 100 depicted in FIG. 1 provides for byte-granular updates to data in the PVRM 108. The architecture of apparatus 100, along with the inclusion of the on-die interface 120, leverages the byte-addressable nature and fast access times associated with PVRM 108 while providing software with visibility of PVRM updates in order to maintain a consistent view of the state of storage.

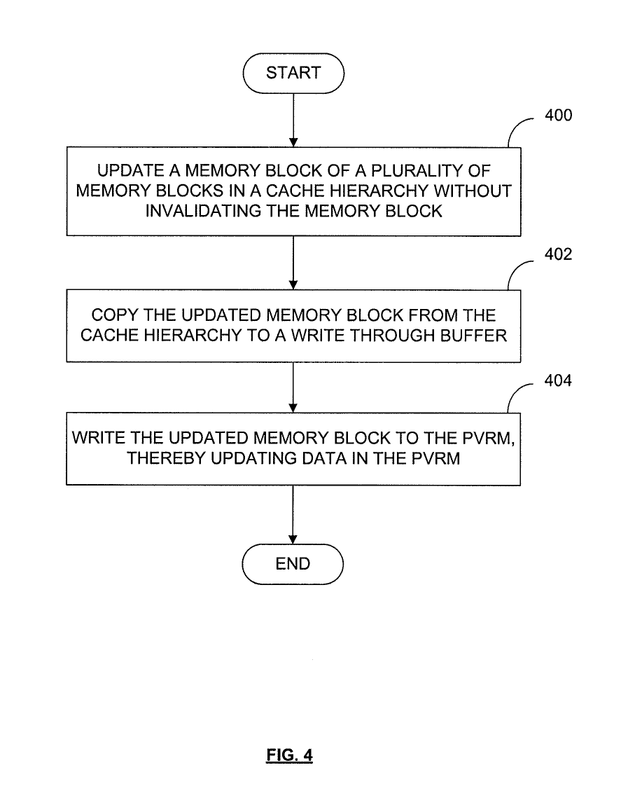

FIG. 4 is a flowchart illustrating one example of a method for updating data in PVRM in accordance with the present disclosure. The method disclosed in FIG. 4 may be carried out by, for example, the apparatus 100 depicted in FIG. 1. At step 400, a memory block of a plurality of memory blocks in a cache hierarchy is updated without invalidating the memory block. In one example, the memory block of the plurality of memory blocks is updated based on a NISIDW executed by a processor. At step 402, the updated memory block is copied from the cache hierarchy to a write through buffer. At step 404, the updated memory block is written to the PVRM, thereby updating the data in the PVRM.

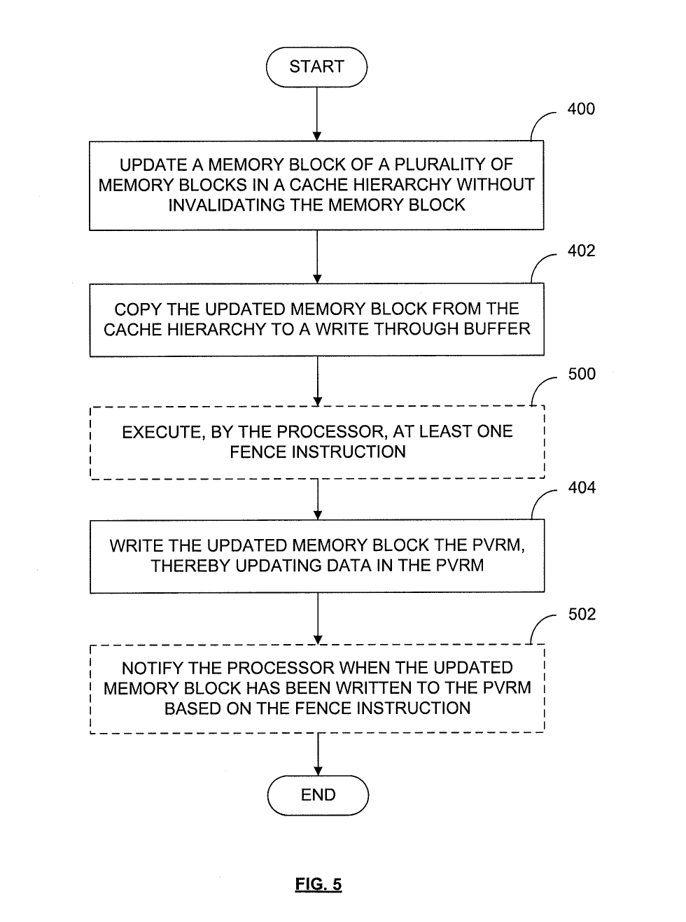

FIG. 5 is a flowchart illustrating another example of a method for updating data in PVRM in accordance with the present disclosure. The method disclosed in FIG. 5 may be carried out by, for example, the apparatus 100 depicted in FIG. 1. Steps 400-404 are carried out as described above with regard to FIG. 4. At step 500, at least one FENCE instruction is executed by a processor. At step 502, the processor is notified when the updated memory block has been written to the PVRM based on the FENCE instruction.

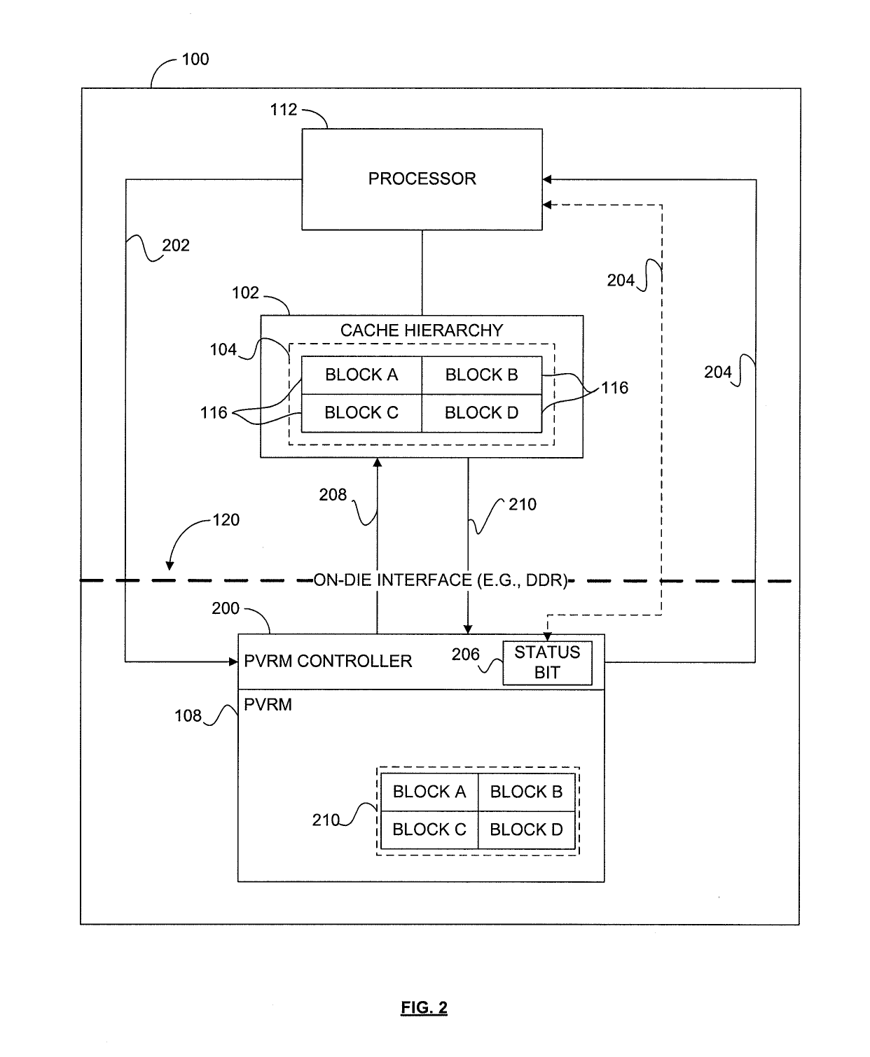

FIG. 2 illustrates another example of the apparatus 100 (i.e., the new persistent storage update mechanism), which may be used for updating data in PVRM 108 in accordance with the present disclosure. The components of the apparatus 100 described above with respect to FIG. 1 represent the components necessary to achieve byte-addressable updates to the data in PVRM 108. However, as will become clear in view of the following discussion regarding FIG. 2, the apparatus 100 may also include components for updating large data files, and/or facilitating batch-updates, to the data in PVRM 108. In other words, the components illustrated in FIG. 1 and the components illustrated in FIG. 2 may coexist in the same apparatus 100 in order to provide a fine-grained persistent storage update mechanism (see, e.g., FIG. 1) and a coarse-grained persistent storage update mechanism (see, e.g., FIG. 2).

The apparatus 100 depicted in FIG. 2 includes a processor 112, such as the processor 112 described above with respect to FIG. 1. The processor 112 is operatively connected to a cache hierarchy 102, such as the cache hierarchy 102, also discussed above with respect to FIG. 1. The cache hierarchy 102 includes a plurality of memory blocks 104 composed of individual memory blocks 116 (e.g., BLOCK A, BLOCK B, etc.). Any of the individual memory blocks 116 may be an updated memory block 118, such as the updated memory block 118 discussed with regard to FIG. 1 above. That is to say, any or all of the plurality of memory blocks 104 may have been previously updated by, for example, a write request 130, such as the write request 130 illustrated in FIG. 1. The cache hierarchy 102 is operatively connected to an PVRM controller 200 over an on-die interface 120, such as the on-die interface 120 discussed above.

The PVRM controller 200 may comprise, for example, a digital circuit capable of managing the flow of data going to and from the PVRM 108, or any other suitable type of memory controller known in the art. In one example, the PVRM controller 200 may be integrated on the same microprocessor die as the processor 112. In any event, the PVRM controller 200 may act as a direct memory access (DMA) engine, as known in the art. In this manner, the PVRM controller 200 may be employed to offload expensive memory operations (e.g., large-scale copies or scatter-gather operations) from the processor 112, so that the processor 112 is available to perform other tasks. The PVRM controller 200 is operatively connected to the PVRM 108 over a suitable communication channel known in the art, such as a bus. The PVRM 108 acts in accordance with the discussion of that component provided above.

The apparatus 100 illustrated in FIG. 2 operates as follows. The processor 112 may transmit control information 202 to the PVRM controller 200. The control information 202 identifies which individual memory blocks(s) 116 should be copied from the cache hierarchy 102 to the PVRM 108. In response to receiving the control information 202, the PVRM controller 200 is operative to copy the identified memory blocks(s) 210 from the cache hierarchy 102 to the PVRM 108, thereby updating the data in the PVRM 108. However, it is recognized that in one embodiment, the PVRM controller 200 may invalidate the identified memory blocks(s) 210 to the PVRM 108, rather than merely copying the identified memory block(s) 210.

Nevertheless, in one example, the PVRM controller 200 is operative to transmit one or more cache probes 208 to the cache hierarchy 102 indicating which individual memory blocks 116 of the plurality of memory blocks 104 should be copied/invalidated to the PVRM 108. In this example, in response to receiving the cache probe(s) 208, the cache hierarchy 102 is operative to transfer data representing the identified memory blocks 210 to the PVRM 108. For example, and with continued reference to FIG. 2, the PVRM 108 is depicted as including identified memory blocks 210. In this manner, the processor 112 is freed-up to perform other operations while the PVRM controller 200 manages the copying/invalidating of the one or more individual memory blocks 116 from the cache hierarchy 102 to the PVRM 108.

Once the identified memory blocks 210 have been transferred to persistent storage in the PVRM 108, the processor may obtain completion notification information 204. The completion notification information 204 is operative to notify the processor 112 that the at least one identified memory block 210 has been copied/invalidated from the cache hierarchy 102 to the PVRM 108. In one example, the processor 112 is operative to obtain the completion notification information 204 by polling a status bit 206 associated with the PVRM controller 200. As used with respect to the embodiments described herein, “polling” may include continuously sampling (e.g., reading) the status bit 206, periodically sampling the status bit 206, sampling the status bit in response to an event, etc. Regardless of the method of polling, the status bit 206 may indicate, for example, whether or not the at least one identified memory block 210 has been copied/invalidated from the cache hierarchy 102 to the PVRM 108. In another example, the processor 112 may obtain the completion notification information 204 by receiving, from the PVRM controller 200, a processor interrupt signal indicating that the at least one identified memory block 210 has been copied/invalidated from the cache hierarchy 102 to the PVRM 108. In this manner, the components of the apparatus 100 illustrated in FIG. 2 may facilitate large-scale transfers of data from the cache hierarchy 102 to long-term storage in the PVRM 108, while simultaneously freeing up to the processor 112 to perform other operations.

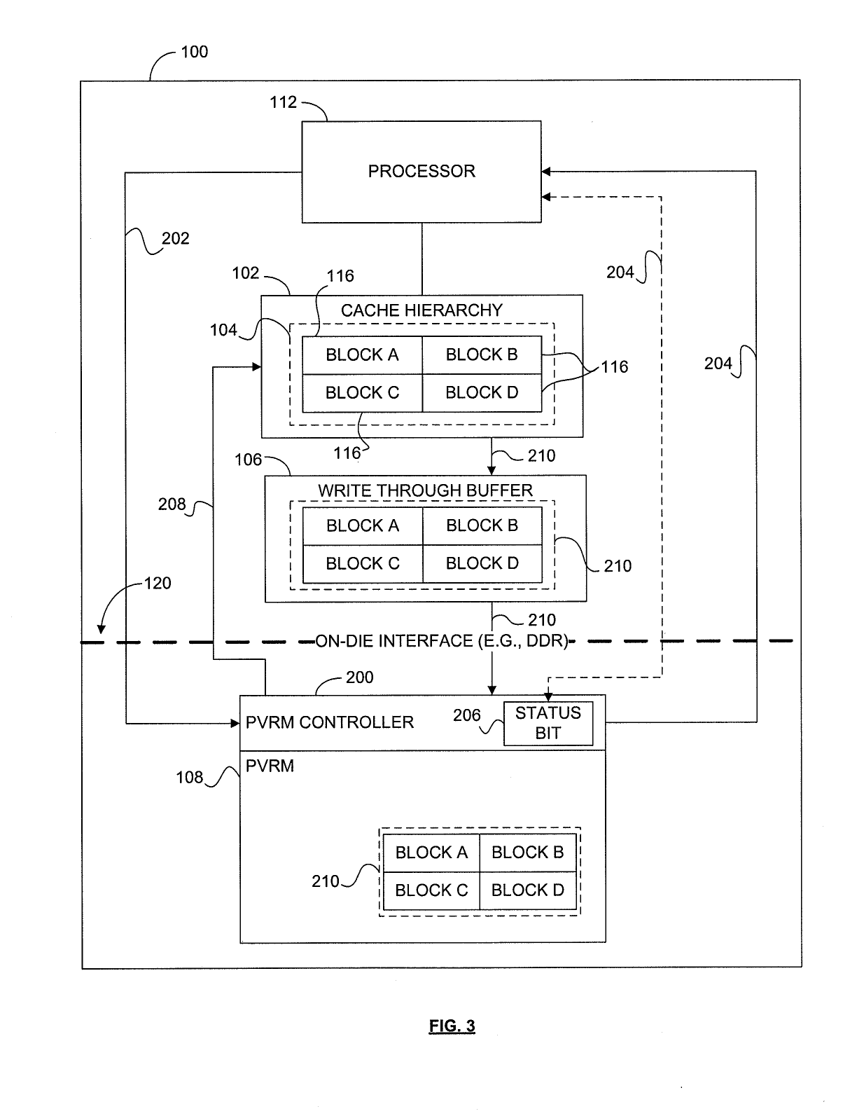

FIG. 3 illustrates yet another example the apparatus 100, which may be used for updating data in PVRM 108 in accordance with the present disclosure. FIG. 3 essentially depicts the coarse-grain update mechanism of FIG. 2, but with the inclusion of a write through buffer 106, such as the write through buffer 106 described above with respect to FIG. 1. In the example of the apparatus 100 illustrated in FIG. 3, the write through buffer 106 may be used as temporary storage for identified memory blocks 210 that have been copied/invalidated from the cache hierarchy 102 but have not yet reached the PVRM 108. As such, the write through buffer 106 may be used to manage the flow of the identified memory blocks 210 from the cache hierarchy 102 to the PVRM 108. Stated another way, the write through buffer 106 may be utilized to prevent a bottleneck-scenario, which may arise when identified memory blocks 210 are slated for transfer to the PVRM 108 faster than the on-die interface 120 is able to consume them.

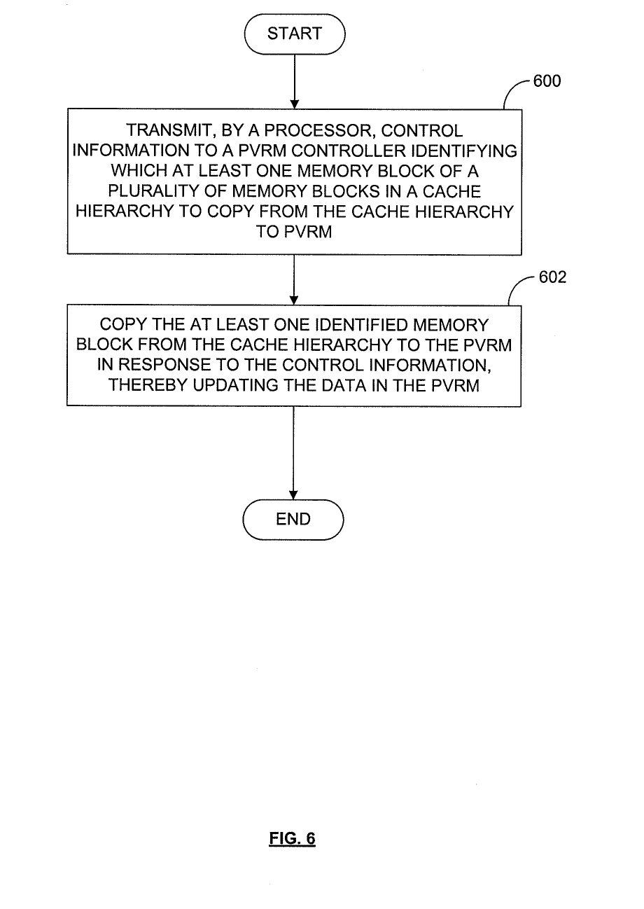

FIG. 6 is a flowchart illustrating one example of a method for updating data in PVRM in accordance with the present disclosure. The method disclosed in FIG. 6 may be carried out by, for example, the apparatus 100 depicted in FIG. 2 and/or FIG. 3. At step 600, a processor transmits control information to an PVRM controller. The control information identifies which at least one memory block of a plurality of memory blocks in a cache hierarchy to copy from the cache hierarchy to the PVRM. At step 602, the at least one identified memory block is copied from the cache hierarchy to the PVRM in response to the control information, thereby updating the data in the PVRM.

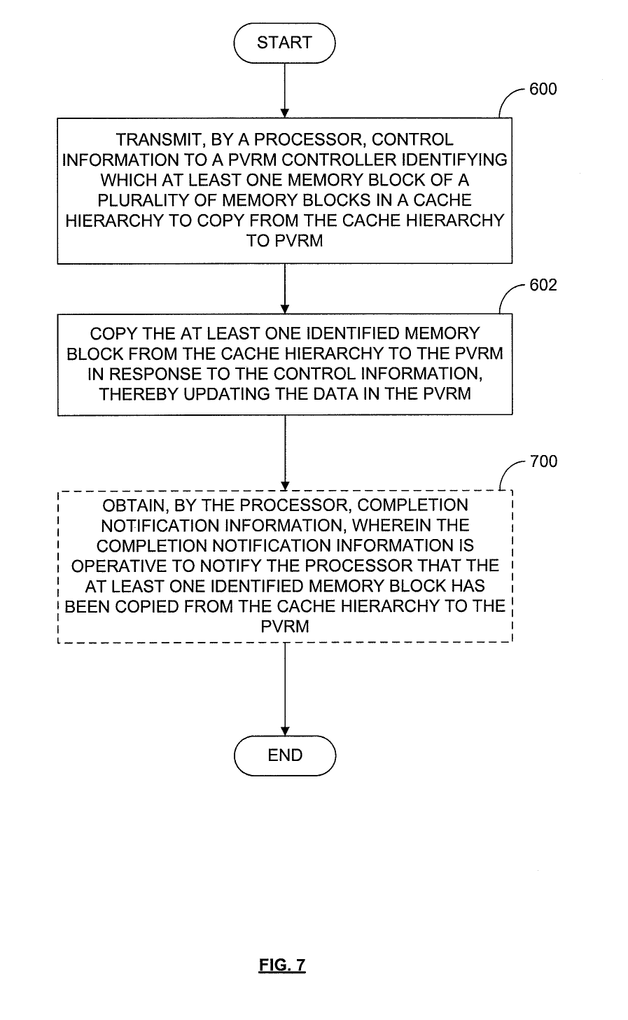

FIG. 7 a flowchart illustrating another example of a method for updating data in PVRM in accordance with the present disclosure. The method disclosed in FIG. 7 may be carried out by, for example, the apparatus 100 depicted in FIG. 2 and/or FIG. 3. Steps 600-602 are carried out in accordance with the discussion of those steps provided above. At step 700, the processor obtains completion notification information. The completion notification information is operative to notify the processor that at least one identified memory block has been copied from the cache hierarchy to the PVRM.

In one example, each PVRM memory cell (e.g., 1 bit) may be a memristor of any suitable design. Since a memristor includes a memory region (e.g., a layer of TiO₂) between two metal contacts (e.g., platinum wires), memristors could be accessed in a cross point array style (i.e., crossed-wire pairs) with alternating current to non-destructively read out the resistance of each memory cell. A crossbar is an array of memory regions that can connect each wire in one set of parallel wires to every member of a second set of parallel wires that intersects the first set (usually the two sets of wires are perpendicular to each other, but this is not a necessary condition). The memristor disclosed herein may be fabricated using a wide range of material deposition and processing techniques. One example is disclosed in U.S. Patent Application Publication No. 2008/0090337 entitled “ELECTRICALLY ACTUATED SWITCH.”

In this example, first, a lower electrode is fabricated using conventional techniques such as photolithography or electron beam lithography, or by more advanced techniques, such as imprint lithography. This may be, for example, a bottom wire of a crossed-wire pair. The material of the lower electrode may be either metal or semiconductor material, preferably, platinum.

In this example, the next component of the memristor to be fabricated is the non-covalent interface layer, and may be omitted if greater mechanical strength is required, at the expense of slower switching at higher applied voltages. In this case, a layer of some inert material is deposited. This could be a molecular monolayer formed by a Langmuir-Blodgett (LB) process or it could be a self-assembled monolayer (SAM). In general, this interface layer may form only weak van der Waals-type bonds to the lower electrode and a primary layer of the memory region. Alternatively, this interface layer may be a thin layer of ice deposited onto a cooled substrate. The material to form the ice may be an inert gas such as argon, or it could be a species such as CO₂. In this case, the ice is a sacrificial layer that prevents strong chemical bonding between the lower electrode and the primary layer, and is lost from the system by heating the substrate later in the processing sequence to sublime the ice away. One skilled in this art can easily conceive of other ways to form weakly bonded interfaces between the lower electrode and the primary layer.

Next, the material for the primary layer is deposited. This can be done by a wide variety of conventional physical and chemical techniques, including evaporation from a Knudsen cell, electron beam evaporation from a crucible, sputtering from a target, or various forms of chemical vapor or beam growth from reactive precursors. The film may be in the range from 1 to 30 nanometers (nm) thick, and it may be grown to be free of dopants. Depending on the thickness of the primary layer, it may be nanocrystalline, nanoporous or amorphous in order to increase the speed with which ions can drift in the material to achieve doping by ion injection or undoping by ion ejection from the primary layer. Appropriate growth conditions, such as deposition speed and substrate temperature, may be chosen to achieve the chemical composition and local atomic structure desired for this initially insulating or low conductivity primary layer.

The next layer is a dopant source layer, or a secondary layer, for the primary layer, which may also be deposited by any of the techniques mentioned above. This material is chosen to provide the appropriate doping species for the primary layer. This secondary layer is chosen to be chemically compatible with the primary layer, e.g., the two materials should not react chemically and irreversibly with each other to form a third material. One example of a pair of materials that can be used as the primary and secondary layers is TiO₂ and TiO₂₋ₓ, respectively. TiO₂ is a semiconductor with an approximately 3.2 eV bandgap. It is also a weak ionic conductor. A thin film of TiO₂ creates the tunnel barrier, and the TiO₂, forms an ideal source of oxygen vacancies to dope the TiO₂ and make it conductive.

Finally, the upper electrode is fabricated on top of the secondary layer in a manner similar to which the lower electrode was created. This may be, for example, a top wire of a crossed-wire pair. The material of the lower electrode may be either metal or semiconductor material, preferably, platinum. If the memory cell is in a cross point array style, an etching process may be necessary to remove the deposited memory region material that is not under the top wires in order to isolate the memory cell. It is understood, however, that any other suitable material deposition and processing techniques may be used to fabricate memristors for the passive variable-resistive memory.

Among other advantages, the disclosed methods and apparatus provide new persistent storage update mechanisms having access speeds compatible with PVRM and a new non-invalidating store instruction with de-coupled writethrough (NISIDW). Executing a NISIDW in a computing system containing the new persistent storage update mechanism provides software with visibility of writeback completion in order to maintain a consistent view of the state of persistent storage (e.g., PVRM). Furthermore, the NISIDW is capable of updating a cache hierarchy and PVRM, without invalidating the updated memory block. Other advantages will be recognized by those of ordinary skill in the art.

Also, integrated circuit design systems (e.g., workstations) are known that create integrated circuits based on executable instructions stored on a computer readable memory such as but not limited to CD-ROM, RAM, other forms of ROM, hard drives, distributed memory, etc. The instructions may be represented by any suitable language such as but not limited to hardware descriptor language or any other suitable language. As such, the apparatus described herein may also be produced as integrated circuits by such systems. For example, an integrated circuit may be created using instructions stored on a computer readable medium that when executed cause the integrated circuit design system to create an integrated circuit that is operative to execute, by a processor, at least one non-invalidating store instruction with de-coupled write through (NISIDW); update a memory block of a plurality of memory blocks in a cache hierarchy without invalidating the memory block based on the NISIDW; copy the updated memory block from the cache hierarchy to a write through buffer; and write the updated memory block to the PVRM, thereby updating the data in the PVRM. Integrated circuits having logic that performs other operations described herein may also be suitably produced.

The above detailed description and the examples described therein have been presented for the purposes of illustration and description only and not by way of limitation. It is therefore contemplated that the present disclosure cover any and all modifications, variations or equivalents that fall within the spirit and scope of the basic underlying principles disclosed above and claimed herein.

What is claimed is:

1. An apparatus comprising:
a cache hierarchy comprising a plurality of memory blocks;
a write through buffer operatively connected to the cache hierarchy;
passive variable resistive memory (PVRM) operatively connected to the write through buffer; and
a processor operatively connected to the cache hierarchy, the processor operative to update a memory block of the plurality of memory blocks in the cache hierarchy without invalidating the memory block, wherein the cache hierarchy is operative to copy the updated memory block to the write through buffer in response to the processor updating the memory block, and wherein the write through buffer is operative to write the updated memory block to the PVRM.

2. The apparatus of claim 1, wherein the PVRM comprises at least one of phase-change memory, spin-torque transfer magnetoresistive memory, and memristor memory.

3. The apparatus of claim 1, wherein the PVRM is operatively connected to the write through buffer over an on-die interface, and wherein the write through buffer is operative to write the updated memory block to the PVRM over the on-die interface.

4. The apparatus of claim 3, wherein the on-die interface comprises a double data rate interface.

5. The apparatus of claim 1, wherein the processor is further operative to execute at least one FENCE instruction, each at least one FENCE instruction causing the write through buffer to notify the processor when it has written the updated memory block to the PVRM.

6. The apparatus of claim 5, further comprising at least one additional processor, wherein the processor and each at least one additional processor have a consistent global view of data in the PVRM following the execution of each at least one FENCE instruction by the processor.

7. The apparatus of claim 1, wherein the cache hierarchy comprises at least one of a level 1 cache, a level 2 cache, and a level 3 cache.

8. The apparatus of claim 1, wherein the PVRM is byte-addressable.

9. A method for updating data in passive variable resistive memory (PVRM), the method comprising:
updating a memory block of a plurality of memory blocks in a cache hierarchy without invalidating the memory block;
copying the updated memory block from the cache hierarchy to a write through buffer; and
writing the updated memory block to the PVRM, thereby updating the data in the PVRM.

10. The method of claim 10, wherein the PVRM comprises at least one of phase-change memory, spin-torque transfer magnetoresistive memory, and memristor memory.

11. The method of claim 9, further comprising:
executing, by the processor, at least one FENCE instruction; and
notifying the processor when the updated memory block has been written to the PVRM based on the FENCE instruction.

12. The method of claim 9, wherein the cache hierarchy comprises at least one of a level 1 cache, a level 2 cache, and a level 3 cache.

13. The method of claim 9, wherein the PVRM is byte-addressable.

14. An apparatus comprising:
a cache hierarchy comprising a plurality of memory blocks; passive variable resistive memory (PVRM);
a PVRM controller operatively connected to the cache hierarchy and the PVRM; and
a processor operatively connected to the PVRM controller, the processor operative to transmit control information to the PVRM controller identifying which at least one memory block of the plurality of memory blocks to copy from the cache hierarchy to the PVRM, wherein the PVRM controller is operative to copy the at least one identified memory block from the cache hierarchy to the PVRM in response to the control information.

15. The apparatus of claim 14, wherein the PVRM comprises at least one of phase-change memory, spin-torque transfer magnetoresistive memory, and memristor memory.

16. The apparatus of claim 14, wherein the processor is operative to obtain completion notification information, wherein the completion notification information is operative to notify the processor that the at least one identified memory block has been copied from the cache hierarchy to the PVRM.

17. The apparatus of claim 16, wherein the processor is operative to obtain the completion notification information by polling a status bit associated with the PVRM controller, wherein the status bit indicates whether or not the at least one identified memory block has been copied from the cache hierarchy to the PVRM.

18. The apparatus of claim 16, wherein the processor is operative to obtain the completion notification information by receiving, from the PVRM controller, a processor interrupt signal indicating that the at least one identified memory block has been copied from the cache hierarchy to the PVRM.

19. The apparatus of claim 14, wherein the PVRM is operatively connected to the cache hierarchy over an on-die interface, and wherein the PVRM controller is operative to copy the at least one identified memory block from the cache hierarchy to the PVRM over the on-die interface.

20. The apparatus of claim 19, wherein the on-die interface comprises a double data rate interface.

21. The apparatus of claim 14, wherein the cache hierarchy comprises at least one of a level 1 cache, a level 2 cache, and a level 3 cache.

22. A method for updating data in passive variable resistive memory (PVRM), the method comprising:
transmitting, by a processor, control information to a PVRM controller identifying which at least one memory block of a plurality of memory blocks in a cache hierarchy to copy from the cache hierarchy to the PVRM;
copying the at least one identified memory block from the cache hierarchy to the persistent file system in PVRM in response to the control information, thereby updating the data in the PVRM.

23. The method of claim 22, wherein the PVRM comprises at least one of phase-change memory, spin-torque transfer magnetoresistive memory, and memristor memory.

24. The method of claim 22, further comprising:
obtaining, by the processor, completion notification information, wherein the completion notification information is operative to notify the processor that the at least one identified memory block has been copied from the cache hierarchy to the PVRM.

25. The method of claim 24, wherein obtaining completion notification information comprises at least one of:
polling, by the processor, a status bit associated with the PVRM controller, wherein the status bit indicates whether or not the at least one identified memory block has been copied from the cache hierarchy to the PVRM; and
receiving, by the processor, a processor interrupt signal from the PVRM controller indicating that the at least one identified memory block has been copied from the cache hierarchy to the PVRM.

26. The method of claim 20, wherein copying the at least one identified memory block from the cache hierarchy to the PVRM comprises copying the least one identified memory block from the cache hierarchy to the PVRM over an on-die interface.

27. The method of claim 26, wherein the on-die interface comprises a double data rate interface.

28. The method of claim 22, wherein the cache hierarchy comprises at least one of a level 1 cache, a level 2 cache, and a level 3 cache.
